(19) United States
(12) Patent Application Publication
(10) Pub. No.: US 2005/0104783 A1
(43) Pub. Date: May 19, 2005

(54) Antenna for portable radio

(75) Inventor: Suguru Kojima, Kanagawa (JP)

Correspondence Address: Stevens Davis;Miller & Mosher, Suite 850, 1615 L Street NW, Washington, DC, 20036, US

(73) Assignee: MATSUSHITA ELECTRIC INDUSTRIAL CO., LTD., Osaka (JP)

(21) Appl. No.: 10/499,904

(22) PCT Filed: Jun. 18, 2003
(86) PCT No.: PCT/JP03/07708

(30) Foreign Application Priority Data
Jun. 25, 2002 (JP) 2002-184003
Sep. 27, 2002 (JP) 2002-282993

(51) Int. Cl. H01Q 1/24

(52) U.S. Cl. 343/702; 343/846

(57) ABSTRACT

A mobile radio apparatus antenna for improving the gain and widening the band is provided. A inverted-L antenna (10) is a feed element with one end thereof electrically connected to one plate surface of a circuit board (12) through a feed point. The circuit board (12) is a circuit board of a mobile radio apparatus, to which the circuit parts including the inverted-L antenna (10) are connected. A planar antenna (14) is provided facing the backside plate surface of the plate surface of the circuit board (12), to which the inverted-L antenna (10) is connected, and is a parasitic element with an electrical length in the length direction set to approximately ½ of the wavelength of radio waves communicated by the mobile radio apparatus. Here, the dimension of the inverted-L antenna (10), the circuit board (12), and the planar antenna (14), and the distance therebetween are adjusted to predetermined values, so as to change the self-impedance of the inverted-L antenna (10), the self-impedance of the planar antenna (14), and the mutual impedance between the inverted-L antenna (10) and the planar antenna (14).

### FIELD OF THE INVENTION

The present invention relates to a mobile radio apparatus antenna.

### TECHNICAL FIELD

In recent years, with the spread of communication apparatuses such as a mobile radio apparatus, further miniaturization is desired. Along with this, a built-in antenna is desired. Conventionally, typical example of this kind of an antenna apparatus is disclosed in Laid Open Japanese Patent Application No. 2001-244715. In order to prevent characteristic deterioration due to the influence of a human body, this antenna is designed to be a built-in antenna that causes no induced current on a radio circuit board by arranging a parasitic element above a feed element.

However, this prior-art built-in antenna has directivity of large radiation in a direction of the human body. Therefore, there is a problem that the transmission reception performance deteriorates due to the influence of the human body. Moreover, in order to improve gain during call, it is preferable that the antenna has the directivity in a direction opposite to the human body.

### DISCLOSURE OF INVENTION

An object of the present invention is to reduce the size and thickness of a mobile radio apparatus, while a gain is improved and a band is widened.

The gist of the present invention is that a planar parasitic element is provided facing the backside surface of a plate surface of a circuit board to which a feed element is connected, and this planar parasitic element having an electrical length of approximately ½ of the wavelength in the length direction is operated as a reflector, so as to increase the gain, reduce the SAR, and widen the band.

The gist of the present invention also includes that an element width of a feed element is made greater than a fixed value, so as to increase the gain, widen the band, reduce the SAR, and make the mobile radio apparatus smaller and thinner.

According to one aspect of the present invention, a mobile radio apparatus antenna has: a circuit board for arranging a circuit of a mobile radio apparatus; a feed element with one end thereof connected to a surface of the circuit board through a feed point; and a parasitic planar antenna element arranged facing an other surface of the circuit board, the element having an electrical length of approximately ½ of a wavelength in a length direction and operating as a reflector.

### BRIEF DESCRIPTION OF THE DRAWINGS

FIG. 1 is a view showing the configuration of a mobile radio apparatus antenna according to a first embodiment of the present invention;

FIG. 2 is a view showing a example of the mobile radio apparatus antenna according to the first embodiment;

FIG. 3A is a view showing an example of frequency band characteristic of the mobile radio apparatus antenna according to the first embodiment;

FIG. 3B is a view showing an example of radiation characteristic of the mobile radio apparatus antenna according to the first embodiment;

FIG. 4 is a view showing the configuration of the mobile radio apparatus antenna according to a second embodiment of the present invention;

FIG. 5 is a view showing the configuration of the mobile radio apparatus antenna according to a third embodiment of the present invention;

FIG. 6 is a view showing the configuration of the mobile radio apparatus antenna according to a fourth embodiment of the present invention;

FIG. 7 is a view showing the configuration of the mobile radio apparatus antenna according to a fifth embodiment of the present invention;

FIG. 8 is a view showing the configuration of the mobile radio apparatus antenna according to a sixth embodiment of the present invention;

FIG. 9 is a view showing the configuration of the mobile radio apparatus antenna according to a seventh embodiment of the present invention;

FIG. 10 is a view showing the configuration of the mobile radio apparatus antenna according to an eighth embodiment of the present invention;

FIG. 11A is a view showing the configuration of the mobile radio apparatus antenna according to a ninth embodiment of the present invention;

FIG. 11B is a view showing the configuration of the parasitic element of the mobile radio apparatus antenna according to the ninth embodiment;

FIG. 12A is a view showing the configuration of the mobile radio apparatus antenna according to a tenth embodiment of the present invention;

FIG. 12B is a view showing a detailed configuration of the mobile radio apparatus antenna according to the tenth embodiment of the present invention;

FIG. 13 is a view showing the configuration of the mobile radio apparatus antenna according to an eleventh embodiment of the present invention;

FIG. 14 is a view showing a example of the mobile radio apparatus antenna according to the eleventh embodiment;

FIG. 15A is a view showing an example of frequency band characteristic of the mobile radio apparatus antenna according to the eleventh embodiment;

FIG. 15B is a view showing an example of a radiation pattern of the mobile radio apparatus antenna according to the eleventh embodiment;

FIG. 15C is a view showing other example of the radiation pattern of the mobile radio apparatus antenna according to the eleventh embodiment;

FIG. 16 is a view showing the configuration of the mobile radio apparatus antenna according to a twelfth embodiment of the present invention; and

FIG. 17 is a view showing the configuration of the mobile radio apparatus antenna according to a thirteenth embodiment of the present invention.

### BEST MODE FOR CARRYING OUT THE INVENTION

Embodiments of the present invention will be explained below with reference to the drawings.

(Embodiment 1)

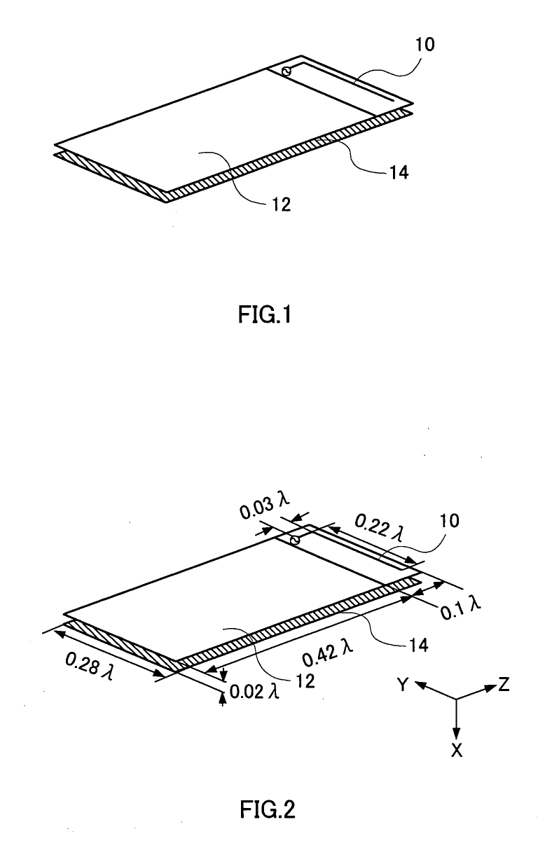

FIG. 1 is a view showing the configuration of a mobile radio apparatus antenna according to a first embodiment of the present invention. The mobile radio apparatus antenna shown in FIG. 1 is configured with a inverted-L antenna 10, a circuit board 12, and a planar antenna 14. The mobile radio apparatus antenna shown in FIG. 1 is built in a mobile radio apparatus.

The inverted-L antenna 10 is a feed element with one end thereof electrically connected to one of the plate surfaces of the circuit board 12 through a feed point. The inverted-L antenna 10 emits/absorbs radio waves.

The circuit board 12 is a circuit board of a mobile radio apparatus, to which circuit parts including the inverted-L antenna 10 are connected.

The planar antenna 14 is a parasitic element provided facing the backside plate surface of the plate surface of the circuit board 12 to which the inverted-L antenna 10 is connected, with an electrical length in the length direction set to approximately ½ of the wavelength of the radio waves communicated by the mobile radio apparatus. The planar antenna 14 is connected to the inverted-L antenna 10 and the circuit board 12 via electromagnetic field coupling, and operates as a reflector.

Here, the dimension of the inverted-L antenna 10, the circuit board 12, and the planar antenna 14, and the distance therebetween are adjusted to predetermined values. Then, by changing the self-impedance of the inverted-L antenna 10, the self-impedance of the planar antenna 14, and the mutual impedance between the inverted-L antenna 10 and the planar antenna 14 (that is, changing the connection capacity between the antennas), the band of the input impedance of the mobile radio apparatus antenna can be widened.

In addition, the planar antenna 14 can be operated as a reflector, thereby having more unidirectional radiation patterns compared with a case where a wire antenna, etc, for example, is operated as a reflector, so that the gain is improved and the SAR (Specific Absorption Rate) is reduced.

FIG. 2 is a view showing a example of the mobile radio apparatus antenna according to this embodiment. In FIG. 2, λ indicates the wavelength of radio waves transmitted/received by the mobile radio apparatus antenna. In FIG. 2, the dimension in the length direction of the planar antenna 14 is 0.52 λ (0.42 λ+0.1 λ), which is approximately ½ of the wavelength. Also, the length of the circuit board 12 is set to 0.42 λ, which is shorter than the planar antenna 14. By adopting the above-described dimensions, the planar antenna 14 resonates with radio waves communicated, causes induced current distribution similar to the planar antenna 14 on the circuit board 12, and operates as a reflector.

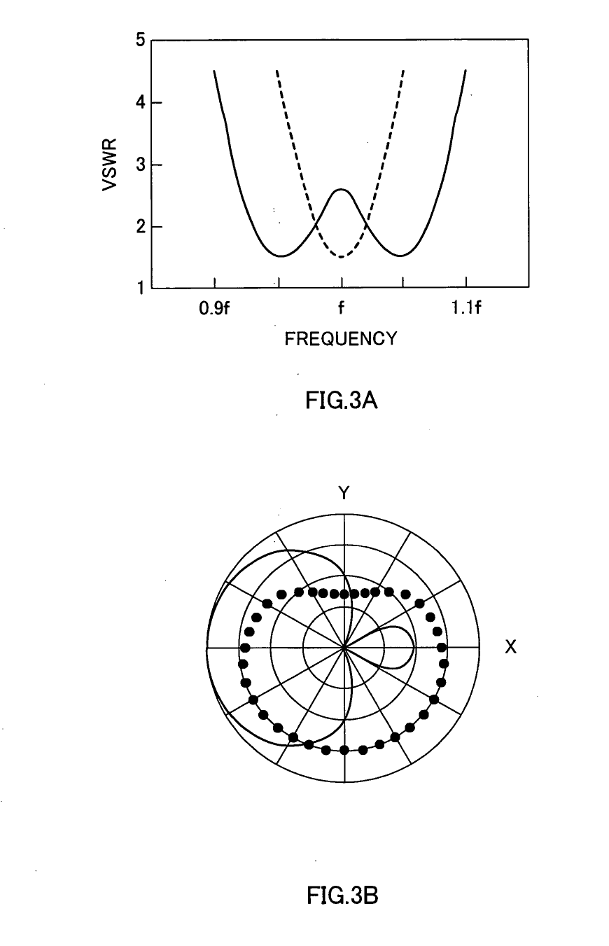

FIG. 3A is a view showing the frequency band characteristic of the above-described mobile radio apparatus antenna. In FIG. 3A, the solid line indicates the VSWR (Voltage Standing Wave Ratio) in each frequency of the above-described mobile radio apparatus antenna, and the broken line indicates the VSWR in each frequency of the mobile radio apparatus antenna having no planar antenna 14. As obvious from the figure, by providing the planar antenna 14, the band can be widened.

FIG. 3B is a view showing the radiation characteristic of the mobile radio apparatus antenna (Eθ component in X-Y plane). In FIG. 3B, the solid line indicates the radiation characteristic of the mobile radio apparatus antenna, and the broken line indicates the radiation characteristic of the mobile radio apparatus antenna having no planar antenna 14. As obvious from the figure, by providing the planar antenna 14 that operates as a reflector, the gain can be improved and the SAR can be reduced.

Thus, according to this embodiment, a parasitic element is provided to widen the band. Further, this parasitic element is made a planar antenna having an electrical length in the length direction approximately ½ of the wavelength of the radio waves communicated, thereby operating as a reflector. As a result, the gain is improved and the SAR is reduced.

(Embodiment 2)

In the mobile radio apparatus antenna according to a second embodiment of the present invention, by meanderingly forming the feed element, the feed element is arranged on the circuit board of a predetermined dimension.

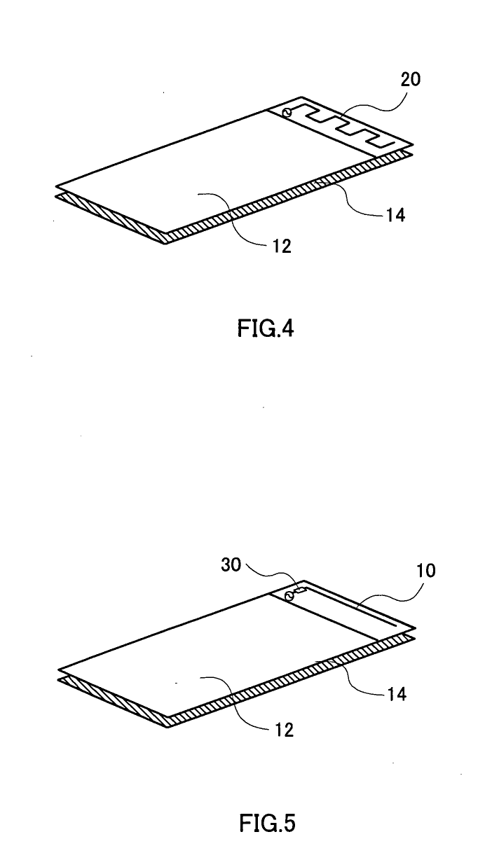

FIG. 4 is a view showing the configuration of the mobile radio apparatus antenna according to the second embodiment. The mobile radio apparatus antenna shown in FIG. 4 includes a meandering antenna 20 instead of the inverted-L antenna 10 of the mobile radio apparatus antenna shown in FIG. 1. The other parts are the same as those of the mobile radio apparatus antenna shown in FIG. 1, and so explanation is omitted here.

The meandering antenna 20 is a feed element with one end thereof electrically connected to one surface of the circuit board 12 through a feed point, and is an antenna element formed meanderingly. The meandering antenna 20 emits/absorbs radio waves.

The planar antenna 14 is connected to the meandering antenna 20 and the circuit board 12 via electromagnetic field coupling, and operates as a reflector.

Here, by adjusting the dimension of the meandering antenna 20, the circuit board 12 and the planar antenna 14, and the distance therebetween, to predetermined values, and by changing the self-impedance of the meandering antenna 20, the self-impedance of the planar antenna 14, and the mutual impedance between the meandering antenna 20 and the planar antenna 14, the input impedance of the mobile radio apparatus antenna can be spread.

In addition, the planar antenna 14 can be operated as a reflector, thereby having more unidirectional radiation/absorption patterns compared with a case where a wire antenna, etc., for example, is operated as a reflector, so that the gain is improved and the SAR is reduced. Further, by adopting the meandering antenna 20 as a feed element, the electrical length of the feed element can be adjusted in accordance with the dimension of the short direction of the circuit board 12, thus attaining the miniaturization of the mobile radio apparatus antenna.

Thus, according to this embodiment, the feed element is formed meanderingly, and therefore, the miniaturization of the mobile radio apparatus antenna is achieved.

(Embodiment 3)

In the mobile radio apparatus antenna according to a third embodiment of the present invention, the inverted-L antenna is provided with a lumped constant, thereby adjusting the self-impedance of the inverted-L antenna.

FIG. 5 is a view showing the configuration of the mobile radio apparatus antenna according to the third embodiment. The portable radio apparatus antenna shown in FIG. 5 has a configuration in which the lumped constant 30 is loaded on the inverted-L antenna 10 of the portable radio apparatus antenna shown in FIG. 1. The other parts are the same as those of the mobile radio apparatus antenna shown in FIG. 1, and so explanation is omitted here.

The lumped constant 30 is loaded on the inverted-L antenna 10, and the self-impedance of the inverted-L antenna 10 is adjusted.

Here, by adjusting the dimension of the inverted-L antenna 10, the circuit board 12, and the planar antenna 14, and the distance therebetween, to predetermined values, and by changing the self-impedance of the inverted-L antenna 10, the self-impedance of the planar antenna 14, and the mutual impedance between the inverted-L antenna 10 and the planar antenna 14, the input impedance of the mobile radio apparatus antenna can be spread. At this time, by adjusting the self-impedance of the inverted-L antenna 10 by the lumped constant 30, the dimension of the inverted-L antenna 10 can be fitted to the dimension of the short direction of the circuit board 12, thus attaining the miniaturization of the mobile radio apparatus antenna.

Thus, according to this embodiment, the lumped constant is loaded on the inverted-L antenna, and therefore the miniaturization of the mobile radio apparatus antenna can be realized.

(Embodiment 4)

In the mobile radio apparatus antenna according to a fourth embodiment of the present invention, the lumped constant is loaded on the planar antenna, thus adjusting the self-impedance of the planar antenna.

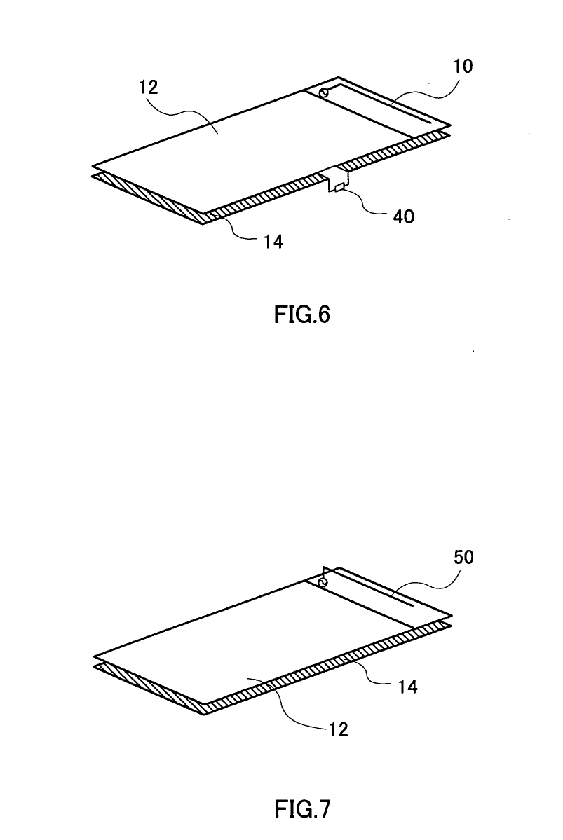

FIG. 6 is a view showing the configuration of the mobile radio apparatus antenna according to the fourth embodiment. The mobile radio apparatus antenna shown in FIG. 6 has a configuration in which the lumped constant 40 is loaded on the planar antenna 14 of the mobile radio apparatus antenna shown in FIG. 1. The other parts are the same as those of the mobile radio apparatus antenna shown in FIG. 1, and so explanation is omitted here.

The lumped constant 40 is loaded on the planar antenna 14, thereby adjusting the self-impedance of the planar antenna 14.

Here, by adjusting the dimension of the inverted-L antenna 10, the circuit board 12, and the planar antenna 14, and the distance therebetween, to predetermined values, and by changing the self-impedance of the inverted-L antenna 10, the self-impedance of the planar antenna 14, and the mutual impedance between the inverted-L antenna 10 and the planar antenna 14, the input impedance of the mobile radio apparatus antenna can be spread. At this time, by adjusting the self-impedance of the planar antenna 14 by the lumped constant 40, the dimension of the planar antenna 14 can be fitted to the dimension of the circuit board 12. Therefore, the miniaturization of the mobile radio apparatus antenna can be realized.

Thus, according to this embodiment, the lumped constant is loaded on the planer antenna, and therefore the miniaturization of the mobile radio apparatus antenna can be realized.

(Embodiment 5)

In the mobile radio apparatus antenna according to a fifth embodiment, the inverted-L antenna is arranged vertical to the circuit board, thus enabling transmission/reception of radio waves vertical to the circuit board.

FIG. 7 is a view showing the configuration of the mobile radio apparatus antenna according to a fifth embodiment. The mobile radio apparatus antenna shown in FIG. 7 has a configuration having the inverted-L antenna 50 instead of the inverted-L antenna 10 of the mobile radio apparatus antenna shown in FIG. 1. The other parts are the same as those of the mobile radio apparatus antenna shown in FIG. 1, and so explanation is omitted here.

The inverted-L antenna 50 is a feed element with one end thereof vertically connected to one surface of the circuit board 12 through a feed point. The inverted-L antenna 50 emits/absorbs radio waves. The inverted-L antenna 50 has a portion that is vertical to the plate surface of the circuit board 12, and therefore radio waves of vertical direction to the plate surface of the circuit board 12 can be transmitted/received.

Here, by adjusting the dimension of the inverted-L antenna 50, the circuit board 12, and the planer antenna 14, and the distance therebetween, to predetermined values, and by changing the self-impedance of the inverted-L antenna 50, the self-impedance of the planer antenna 14, and the mutual impedance between the inverted-L antenna 50 and the planer antenna 14, the input impedance of the mobile radio apparatus antenna can be spread. In addition, the planer antenna 14 can be operated as a reflector, thereby having more unidirectional radiation/absorption patterns compared with a case where a wire antenna, etc., is operated as a reflector for example, and therefore the gain is improved and the SAR is reduced.

Thus, according to this embodiment, the inverted-L antenna has a portion that is vertical to the circuit board, and therefore transmission/reception of radio waves vertical to the circuit board is enabled.

(Embodiment 6)

In the mobile radio apparatus antenna according to a sixth embodiment, the feed element is formed in a inverted-F antenna, thereby adjusting the self-impedance of the feed element.

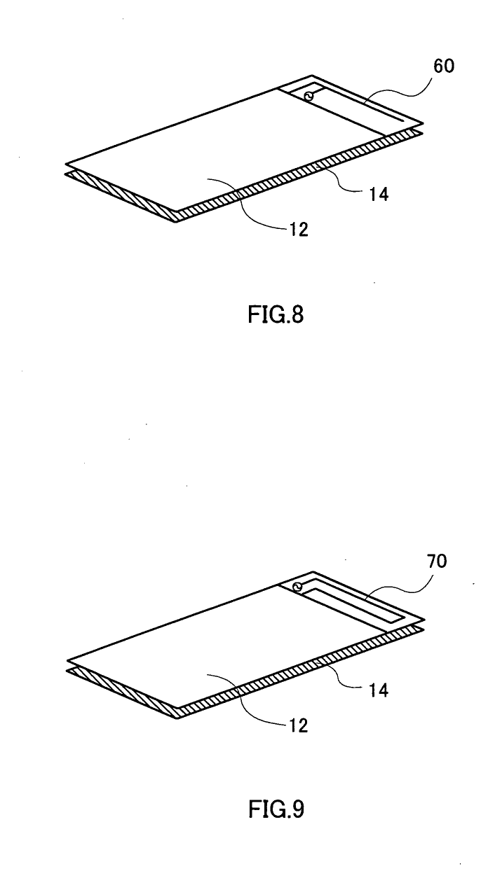

FIG. 8 is view showing the configuration of the mobile radio apparatus antenna according to the sixth embodiment. The mobile radio apparatus antenna shown in FIG. 8 has a configuration having the inverted-F antenna 60 instead of the inverted-L antenna 10 of the mobile radio apparatus antenna shown in FIG. 1. The other parts are the same as those of the mobile radio apparatus antenna shown in FIG. 1, and so explanation is omitted here.

The inverted-F antenna 60 is a feed element, with one of the three ends thereof is electrically connected to one plate surface of the circuit board 12 through a feed point, and the antenna element is formed in the inverted-F shape. The inverted-F antenna 60 emits/absorbs radio waves.

Here, by adjusting the dimension of the inverted-F antenna 60, the circuit board 12, and the planer antenna 14, and the distance therebetween, to predetermined values, and by changing the self-impedance of the inverted-F antenna 60, the self-impedance of the planer antenna 14, and the mutual impedance between the inverted-F antenna 60 and the planer antenna 14, the input impedance of the mobile radio apparatus antenna can be spread. In addition, the planer antenna 14 can be operated as a reflector, thereby having more unidirectional radiation/absorption patterns compared with a case where a wire antenna, etc., is operated as a reflector for example, and therefore the gain is improved and the SAR is reduced.

Thus, according to this embodiment, a parasitic element is provided to widen the band. Further, this parasitic element is made a planer antenna having an electrical length in the length direction approximately ½ of the wavelength of the radio waves communicated, thereby operating as a reflector. As a result, the gain is improved and the SAR is reduced.

(Embodiment 7)

In the mobile radio apparatus antenna according to a seventh embodiment of the present invention, the feed element is formed into folded-shape, thereby adjusting the self-impedance of the feed element.

FIG. 9 is a view showing the configuration of the mobile radio apparatus antenna according to the seventh embodiment. The mobile radio apparatus antenna shown in FIG. 9 has a configuration having a folded antenna 70 instead of the inverted-L antenna 10 of the mobile radio apparatus antenna shown in FIG. 1. The other parts are the same as those of the mobile radio apparatus antenna shown in FIG. 1, and so explanation is omitted here.

The folded antenna 70 is a feed element with one end thereof electrically connected to one plate surface of the circuit board 12 through a feed point and the other end thereof connected to the circuit board 12, and the antenna element is formed into folded-shape. The folded antenna 70 emits/absorbs radio waves.

Here, by adjusting the dimension of the folded antenna 70, the circuit board 12, and the planer antenna 14, and the distance therebetween, to predetermined values, and by changing the self-impedance of the folded antenna 70, the self-impedance of the planer antenna 14, and the mutual impedance between the folded antenna 70 and the planer antenna 14, the input impedance of the mobile radio apparatus antenna can be spread.

In addition, the planer antenna 14 can be operated as a reflector, thereby having more unidirectional radiation/absorption patterns compared with a case where a wire antenna, etc., is operated as a reflector for example, and therefore the gain is improved and the SAR is reduced.

Thus, according to this embodiment, a parasitic element is provided to widen the band. Further, this parasitic element is made a planer antenna having an electrical length in the length direction approximately ½ of the wavelength of the radio waves communicated, thereby operating as a reflector. As a result, the gain is improved and the SAR is reduced.

(Embodiment 8)

In the mobile radio apparatus antenna according to an eighth embodiment of the present invention, by providing a slot in the circuit board, the miniaturization and light weight of the mobile radio apparatus antenna is achieved.

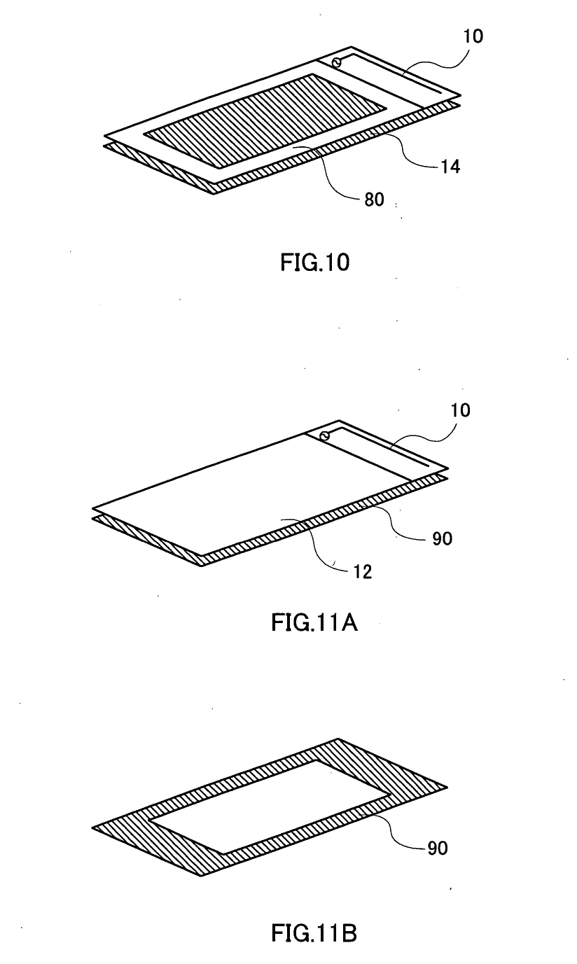

FIG. 10 is a view showing the configuration of the mobile radio apparatus antenna according to the eighth embodiment. The mobile radio apparatus antenna shown in FIG. 10 has a configuration having a circuit board 80 instead of the circuit board 12 of the mobile radio apparatus antenna shown in FIG. 1. The other parts are the same as those of the mobile radio apparatus antenna shown in FIG. 1, and so explanation is omitted here.

The circuit board 80 is a circuit board of the mobile radio apparatus, to which the circuit parts including the inverted-L antenna 10 are connected, and has the slot, which is a hollow portion, in the center.

Here, by adjusting the dimension of the inverted-L antenna 10, the circuit board 80, and the planer antenna 14, and the distance therebetween to predetermined values, and by changing the self-impedance of the inverted-L antenna 10, the self-impedance of the planer antenna 14, and the mutual impedance between the inverted-L antenna 10 and the planer antenna 14, the input impedance of the mobile radio apparatus antenna is spread.

In addition, the planer antenna 14 can be operated as a reflector, thereby having more unidirectional radiation/absorption patterns compared with a case where a wire antenna, etc., is operated as a reflector for example, and therefore the gain is improved and the SAR is reduced.

Further, when transmission/reception operation of radio waves is conducted by the mobile radio apparatus antenna, current flows to the circuit board 80. However, the current flows mainly through the edge portion of the circuit board 80, and therefore the transmission/reception characteristic of the mobile radio apparatus antenna is not influenced.

Thus, according to this embodiment, by providing the slot in the center of the circuit board, the miniaturization and light weight of the mobile radio apparatus antenna is achieved.

(Embodiment 9)

In the mobile radio apparatus antenna according to a ninth embodiment of the present invention, by providing the slot in the planer antenna, the miniaturization and light weight of the antenna is achieved.

FIG. 11A is a view showing the configuration of the mobile radio apparatus antenna according to the ninth embodiment. The mobile radio apparatus antenna shown in FIG. 11A has a configuration having a planer antenna 90 instead of the planer antenna 14 of the mobile radio apparatus antenna shown in FIG. 1. The other parts are the same as those of the mobile radio apparatus antenna shown in FIG. 1, and so explanation is omitted here.

The planer antenna 90 is a parasitic element which is provided facing the backside plate surface of the plate surface of the circuit board 12, to which the L-shaped antenna 10 is connected, with an electrical length in the length direction set to approximately ½ of the wavelength of radio waves communicated by the mobile radio apparatus, and which has a slot, that is, a hollow portion, in the center (see FIG. 11B). The planer antenna 90 is connected to the inverted-L antenna 10 and the circuit board 12 via electromagnetic field coupling, and is operated as a reflector.

Here, by adjusting the dimension of the inverted-L antenna 10, the circuit board 12, and the planer antenna 90, and the distance therebetween to predetermined values, and by changing the self-impedance of the inverted-L antenna 10, the self-impedance of the planer antenna 90, and the mutual impedance between the inverted-L antenna 10 and the planer antenna 90, the input impedance of the mobile radio apparatus antenna is spread.

In addition, the planer antenna 90 can be operated as a reflector, thereby having more unidirectional radiation/absorption patterns compared with a case where a wire antenna, etc., is operated as a reflector for example, and therefore the gain is improved and the SAR is reduced.

Further, when transmission/reception operation of radio waves is conducted by the mobile radio apparatus antenna, current flows to the planer antenna 90. However, the current flows mainly through the edge portion of the planer antenna 90. Therefore the transmission/reception characteristic of the mobile radio apparatus antenna is not influenced.

Thus, according to this embodiment, a slot is provided in the center of the planer antenna. Therefore, the miniaturization and light weight of the mobile radio apparatus antenna can be realized.

(Embodiment 10)

In the mobile radio apparatus antenna according to a tenth embodiment of the present invention, by inserting a dielectric material into a gap between the circuit board and the planer antenna, the circuit board and the planer antenna have a shortened distance therebetween, are made thinner, and are made integral.

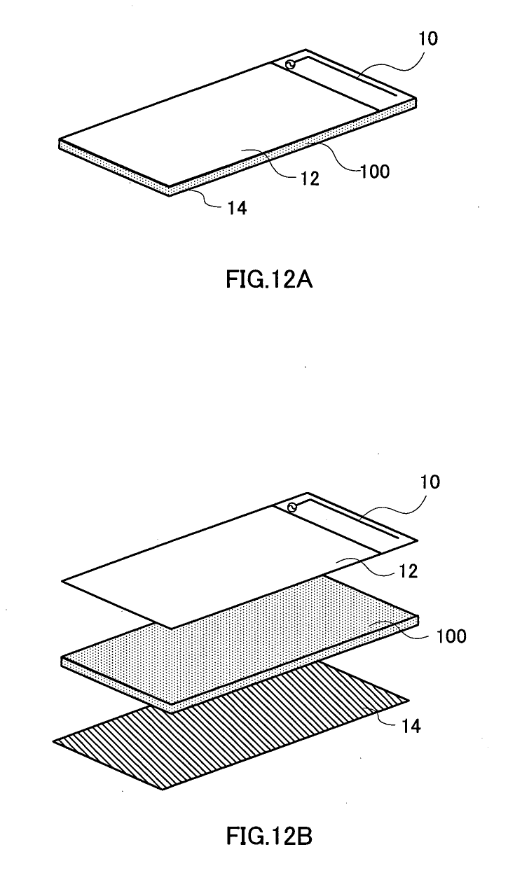

FIG. 12A is a view showing the configuration of the mobile radio apparatus antenna according to the tenth embodiment. The mobile radio apparatus antenna shown in FIG. 12A has a configuration having a dielectric material 100 in addition to the mobile radio apparatus antenna shown in FIG. 1.

The dielectric material 100 is inserted into the gap between the circuit board 12 and the planer antenna 14 (see FIG. 12B).

Here, by adjusting the dimension of the inverted-L antenna 10, the circuit board 12, and the planer antenna 14, and the distance therebetween to predetermined values, and by changing the self-impedance of the inverted-L antenna 10, the self-impedance of the planer antenna 14, and the mutual impedance between the inverted-L antenna 10 and the planer antenna 14, the input impedance of the mobile radio apparatus antenna is spread.

In addition, the planer antenna 14 can be operated as a reflector, thereby having more unidirectional radiation/absorption patterns compared with a case where a wire antenna, etc., is operated as a reflector for example, and therefore the gain is improved and the SAR is reduced.

Moreover, by inserting the dielectric material 100 into the gap between the circuit board 12 and the planer antenna 14, the distance between the circuit board 12 and the planar antenna 14 is shortened and the mobile radio apparatus antenna can be integrally constituted.

Thus, according to this embodiment, the dielectric material is inserted into the gap between the circuit board and the planar antenna. Accordingly, the mobile radio apparatus antenna can be made thinner and integrally formed.

(Embodiment 11)

In the mobile radio apparatus antenna according to an eleventh embodiment, the feed element is shaped like a thin plate, thereby reducing the gap between the feed element and the parasitic element.

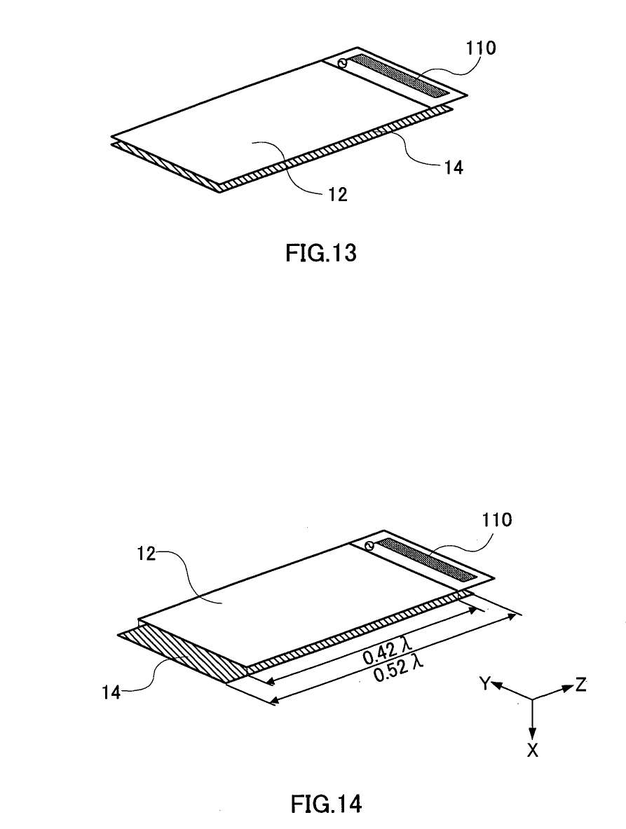

FIG. 13 is a view showing the configuration of the mobile radio apparatus antenna according to the eleventh embodiment. The mobile radio apparatus antenna shown in FIG. 13 has a configuration having a planar inverted-L antenna 110 instead of the inverted-L antenna 10 of the mobile radio apparatus antenna shown in FIG. 1. The other parts are the same as those of the mobile radio apparatus antenna shown in FIG. 1, and so explanation is omitted here.

The planar inverted-L antenna 110 is a feed element with one end thereof electrically connected to one plate surface of the circuit board 12 through a feed point, and the element width in the short direction of the circuit board 12 is set to be greater than a fixed width. The planar inverted-L antenna 110 emits/absorbs radio waves.

Here, by adjusting the dimension of the plannar inverted-L antenna 110, the circuit board 12, and the planar antenna 14, and the distance therebetween to predetermined values, and by changing the self-impedance of the plannar inverted-L antenna 110, the self-impedance of the planar antenna 14, and the mutual impedance between the plannar inverted-L antenna 110 and the planar antenna 14 (that is, by changing the connection capacity between the antennas), the band of the mobile radio apparatus antenna is widened, especially in the transmission frequency band.

Meanwhile, by making the element width of the plannar inverted-L antenna 110 thicker, even when the gap between the plannar inverted-L antenna 110 and the planar antenna 14 is made smaller, the band can be ensured, especially in the transmission frequency band. As a result, the mobile radio apparatus antenna can be made smaller and thinner. FIG. 14 is a view showing a example of the mobile radio apparatus antenna according to this embodiment. In FIG. 14, λ indicates the wavelength of radio waves transmitted/received by the mobile radio apparatus antenna. In FIG. 14, the dimension of the planar antenna 14 in the length direction is 0.52 λ, which is approximately ½ of the wavelengths. Also, the length of the circuit board 12 is set to 0.42 λ, which is shorter than the length of the planar antenna 14. By adopting the above-described dimensions, the planar antenna 14 resonates with radio waves communicated, causes induced current distribution similar to the planar antenna 14 on the circuit board 12, and operates as a reflector.

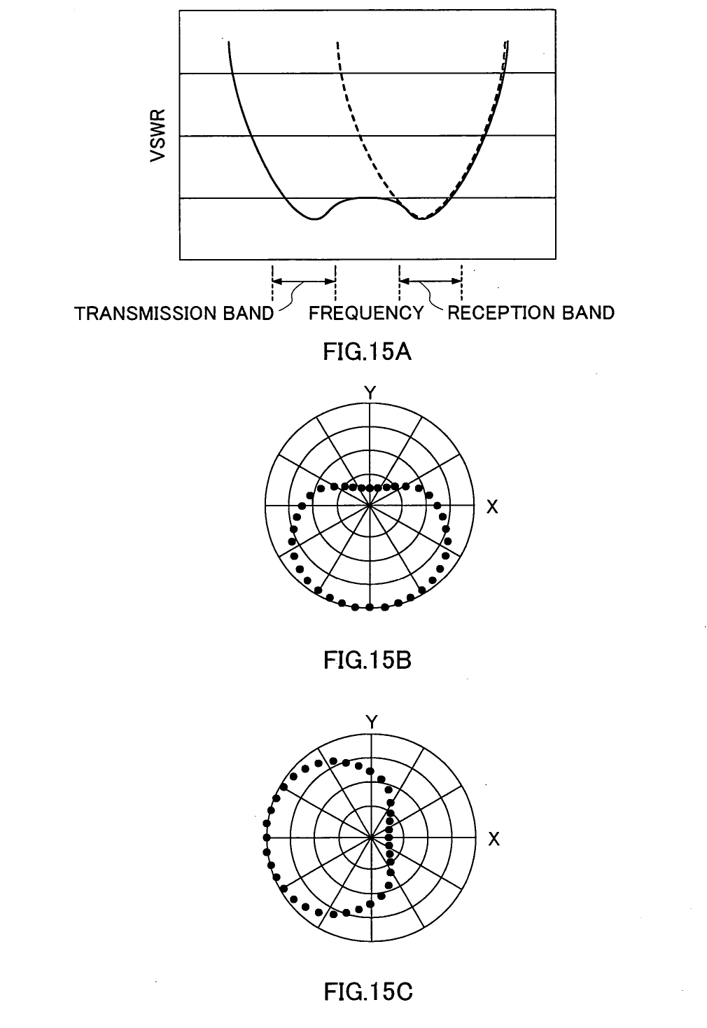

FIG. 15A is a view showing the frequency band characteristic of the mobile radio apparatus antenna. In FIG. 15A, the solid line indicates the VSWR (Voltage Standing Wave Ratio) in each frequency of the mobile radio apparatus antenna, and the broken line indicates the VSWR in each frequency of the mobile radio apparatus antenna having no planar antenna 14. As obvious from the figure, by providing the planar antenna 14, broadband can be achieved, especially in the transmission frequency band.

FIG. 15B is a view showing a radiation pattern (vertical component in X-Y plane) in the reception frequency band of the mobile radio apparatus antenna. FIG. 15C is a view showing the radiation pattern (vertical component in X-Y plane) in the transmission frequency band of the mobile radio apparatus antenna. As obvious from FIG. 15C, by providing the planar antenna 14 that operates as a reflector, the mobile radio apparatus antenna of this embodiment has the directivity in a direction (-X direction) opposite to the human body in the transmission frequency band.

Thus, according to this embodiment, a parasitic element is provided to widen the band. Further, this parasitic element is made a planar antenna having an electrical length in the length direction approximately ½ of the wavelength of the radio waves communicated, thereby operating as a reflector, and making the element width of the feed element thicker. As a result, the gain is improved and the SAR is reduced, and the mobile radio apparatus antenna made smaller and thinner.

(Embodiment 12)

In the mobile radio apparatus antenna according to a twelfth embodiment, a lumped constant is loaded on the planar inverted-L antenna, thereby adjusting the self-impedance of the planar inverted-L antenna.

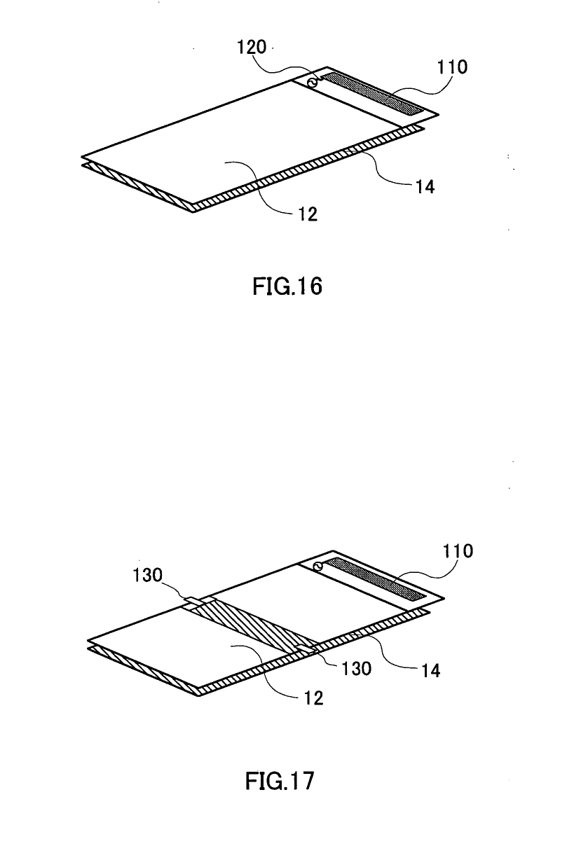

FIG. 16 is a view showing the configuration of the mobile radio apparatus antenna according to the twelfth embodiment. The mobile radio apparatus antenna shown in FIG. 16 has a configuration in which a lumped constant 120 is loaded on the planar inverted-L antenna 110 of the mobile radio apparatus antenna shown in FIG. 13. The other parts are the same as those of the mobile radio apparatus antenna shown in FIG. 13, and so explanation is omitted here.

The lumped constant 120 is loaded on the planar inverted-L shaped antenna 110, and the self-impedance of the planar inverted-L antenna 110 is adjusted.

Here, by adjusting the dimension of the planar inverted-L antenna 110, the circuit board 12, and the planar antenna 14, and the distance therebetween to predetermined values, and by changing the self-impedance of the planar inverted-L antenna 110, the self-impedance of the planar antenna 14, and the mutual impedance between the planar inverted-L antenna 110 and the planar antenna 14 (that is, by changing the connection capacity between the antennas), the band of the mobile radio apparatus antenna is widened, especially in the transmission frequency band. At this time, by adjusting the self-impedance of the planar inverted-L antenna 110 by the lumped constant 120, the dimension of the planar inverted-L antenna 110 can be fitted to the dimension of the short direction of the circuit board 12. The miniaturization of the mobile radio apparatus antenna can be thus achieved.

Meanwhile, by making the element width of the planar inverted-L antenna 110 thicker, even when the gap between the planar inverted-L antenna 110 and the planar antenna 14 is made smaller, the band can be ensured, especially in the reception frequency band. As a result, the mobile radio apparatus antenna can be made smaller and thinner.

Thus, according to this embodiment, the lumped constant is loaded on the feed element, and therefore the mobile radio apparatus antenna can be made further smaller.

(Embodiment 13)

In the mobile radio apparatus antenna according to a thirteenth embodiment, by loading the lumped constant on the circuit board, the self-impedance of the circuit board is adjusted.

FIG. 17 is a view showing the configuration of the mobile radio apparatus antenna according to the thirteenth embodiment. The mobile radio apparatus antenna shown in FIG. 17 has a configuration in which a lumped constant 130 is loaded on the circuit board 12 of the mobile radio apparatus antenna shown in FIG. 13. The other parts are the same as those of the mobile radio apparatus antenna shown in FIG. 13, and so explanation is omitted here.

The lumped constant 130 is loaded on the circuit board 12, and the self-impedance of the circuit board 12 is adjusted.

Here, by adjusting the dimension of the planar inverted-L antenna 110, the circuit board 12, and the planar antenna 14, and the distance therebetween to predetermined values, and by changing the self-impedance of the planar inverted-L antenna 110, the self-impedance of the planar antenna 14, and the mutual impedance between the planar inverted-L antenna 110 and the planar antenna 14 (that is, by changing the connection capacity between the antennas), the band of the mobile radio apparatus antenna is widened, especially in the transmission frequency band. At this time, by adjusting the self-impedance of the circuit board 12 by the lumped constant 130, the dimension of the circuit board 12 can be set to a desired value. The miniaturization of the mobile radio apparatus antenna can be thus attained.

Meanwhile, by making the element width of the planar inverted-L antenna 110 thicker, even when the gap between the planar inverted-L antenna 110 and the planar antenna 14 is made smaller, the band can be ensured especially in the reception frequency band. As a result, the mobile radio apparatus antenna can be made smaller and thinner.

Thus, according to this embodiment, the lumped constant is loaded on the circuit board, and therefore the mobile radio apparatus antenna can be made further smaller.

Note that the above embodiments can be implemented in various combinations.

For example, it is possible to make a feed element thicker in width and thus in a planar shape and then make the shape of the feed element a inverted-F, or arrange a inverted-L antenna vertical on a circuit board.

As described above, according to the present invention, the mobile radio apparatus can be made smaller and thinner, while the gain is improved and the band is widened.

The present application is based on Japanese Patent Application No. 2002-184003 filed on Jun. 25, 2002, and Japanese Patent Application No. 2002-282993 filed on Sep. 27, 2002, entire content of which is expressly incorporated herein by reference.

### INDUSTRIAL APPLICABILITY

The present invention is applicable to antenna for mobile radio apparatuses including, for example, cellular phones.

1. A mobile radio apparatus antenna, comprising:
a circuit board for arranging a circuit of a mobile radio apparatus;
a feed element with one end thereof connected to a plate surface of the circuit board through a feed point; and
a parasitic planar antenna element arranged facing an other surface of the circuit board, said element having an electrical length of approximately ½ of a wavelength in a length direction and operating as a reflector.

2. The mobile radio apparatus antenna according to claim 1, wherein the feed element has an element width greater than a predetermined value.

3. The mobile radio apparatus antenna according to claim 1, wherein the feed element is a inverted-L antenna.

4. The mobile radio apparatus antenna according to claim 1, wherein the feed element comprises a meandering portion in a short direction of the circuit board.

5. The mobile radio apparatus antenna according to claim 1, wherein the feed element has a portion vertical to a surface of the circuit board.

6. The mobile radio apparatus antenna according to claim 1, wherein the feed element is a inverted-F antenna.

7. The mobile radio apparatus antenna according to claim 1, wherein the feed element comprises:
a first inverted-L anntena element with one end thereof connected to one plate surface of the circuit board via the feed point;
a second inverted-L anntena element section with one end thereof connected to the one surface of the circuit board; and
an element connected to an other end of the first inverted-L anntena element and of the second inverted-L anntena element.

8. The mobile radio apparatus antenna, wherein at least one of the circuit board, the feed element, and the planar antenna element comprises a lumped constant for self-impedance adjustment.

9. The mobile radio apparatus antenna according to claim 1, wherein the circuit board has a hollow portion in the center of a plate surface.

10. The mobile radio apparatus antenna according to claim 1, wherein the planar antenna element comprises a hollow portion in a center of a surface parallel to the plate surface of the circuit board.

11. The mobile radio apparatus antenna according to claim 1 further comprising a dielectric material in a gap between the circuit board and the planar antenna element.
